(19) United States
(12) Patent Application Publication
(10) Pub. No.: US 2012/0014136 A1
(43) Pub. Date: Jan. 19, 2012

(54) LIGHT GUIDE PLATE AND BACKLIGHT UNIT INCLUDING THE SAME

(76) Inventors: Dong Seok Lee, Gyeonggi-do (KR); Jae Jin Kim, Gyeonggi-do (KR); Jun Ho Bae, Gyeonggi-do (KR); Yong-Ik Hwang, Gyeonggi-do (KR); Hee-Kyung Lee, Gyeonggi-do (KR)

(21) Appl. No.: 12/972,588

(22) Filed: Dec. 20, 2010

(30) Foreign Application Priority Data
Jul. 16, 2010 (KR) 10-2010-0068961

(51) Int. Cl. F21V 7/04

(52) U.S. Cl. 362/625

(57) ABSTRACT

A light guide plate having a pattern to minimize generation of a dark zone and a backlight unit including the same are disclosed. The light guide plate includes an intaglio pattern consisting of recesses formed in a surface opposite to a light emitting surface thereof to have a cross section having major-axis and minor-axis diameters and depth, the recesses being spaced apart from one another in first and second directions by first and second distances respectively. The density of the intaglio pattern is directly proportional to the major-axis and minor-axis diameters and depth, and is inversely proportional to the first and second distances. The intaglio pattern has the minimum density in a first region adjacent to a light source, and the maximum density in a second region that is the maximum distance from the light source. A density ratio of the maximum density to the minimum density is 900.

This application claims the benefit of Korean Patent Application No. P2010-0068961, filed on, Jul. 16, 2010, which is hereby incorporated by reference as if fully set forth herein.

### BACKGROUND OF THE INVENTION

1. Field of the Invention

The present invention relates to a light guide plate, which converts light, irradiated from a light source located at a corner thereof, into planar light, and a backlight unit including the same.

2. Discussion of the Related Art

Due to advancements in information technology, display devices for visually representing electric signals containing information have been developed rapidly. According to the development of display devices, a variety of flat display devices having excellent characteristics, such as a slim profile, light weight, and low electricity consumption have been developed and are replacing a conventional Cathode Ray Tube (CRT).

Concrete examples of flat display devices include a Liquid Crystal Display (LCD) device, Organic Light Emitting Display (OLED) device, electrophoretic E-Paper Display (EPD) device, Plasma Display Panel (PDP) device, Field Emission Display (FED) device, Electro-Luminescent Display (ELD) device, and Electro-Wetting Display (EWD) device. All of the above mentioned flat display devices commonly include, as an essential component, a flat display panel for displaying an image. The flat display panel is configured such that a pair of substrates is bonded to face each other with a specific light emitting material or polarizing material layer interposed therebetween.

Of the above mentioned flat display devices, a liquid crystal display device displays an image by adjusting the intensity of light emitted from a BackLight Unit (BLU) located at the bottom thereof. Specifically, the liquid crystal display device includes a liquid crystal display panel to adjust the intensity of light, but the liquid crystal display panel is a non-light emitting component. Therefore, it is necessary to arrange the backlight unit below the liquid crystal display panel to irradiate light to the liquid crystal display panel.

The backlight unit is classified, according to the position of a light supply source, into a direct type backlight unit and an edge type backlight unit. In the direct type backlight unit, a plurality of light sources is spaced apart from one another by a predetermined distance on a lower surface of a liquid crystal display panel. A liquid crystal display device including the direct type backlight unit may have a thick profile required to arrange the plurality of light sources at positions corresponding to a display region, but may be suitable for high brightness display. In the edge type backlight unit, at least one light source is located on at least one edge of a lower surface of a liquid crystal display panel. A liquid crystal display device including the edge type backlight unit may have a slim profile owing to arrangement of the light source in a non display region, but may be unsuitable for high brightness display because the number of light sources been capable of locating in the non display region, is limited.

In the meantime, the backlight unit generally further includes a light guide plate that converts light, irradiated from the light source, into planar light suitable for a planar display region. In the case of the direct type backlight unit, the plurality of light sources is arranged in parallel below the display region, such that a distance between the light guide plate and each of the plurality of light sources is relatively constant, thus it is possible that the quantity of the light supplied to the light guide plate is relatively constant. On the other hand, in the case of the edge type backlight unit, the light source is arranged at the edge of the display region, such that a partial region of the light guide plate is close to the light source and another partial region is distant from the light source. Therefore, the partial region of the light guide plate close to the light source receives a great quantity of light, but another partial region distant from the light source receives a smaller quantity of light. This makes it impossible for the light guide plate to uniformly emit light from the entire surface thereof, and the partial region of the light guide plate may be brighter or darker than other regions, causing generation of a dark zone.

To solve the above described problem, forming a protruding pattern on a rear surface of a conventional light guide plate to uniformly supply light even to a partial region distant from a light source, has been proposed.

FIG. 1 is a light emission diagram of a conventional light guide plate having a protruding pattern, and FIG. 2 is an image of emission light of the light guide plate illustrated in FIG. 1.

As illustrated in FIG. 1, light emitted from a light source 10 proceeds to a region of a light guide plate distant from the light source 10 by penetrating the interior of the light guide plate 11. In this case, a protruding pattern 12 formed at a rear surface of the light guide plate 11 acts to change a reflection angle of the light penetrating the interior of the light guide plate 11 such that at least a part of the light totally reflected in the light guide plate 11 is emitted to the outside. This may reduce the quantity of light restrained in the light guide plate 11. Moreover, it may be possible to control the quantity of light emitted from the light guide plate 11 on a per light emitting surface region basis by controlling the density of the protruding pattern 12 and consequently, to reduce the generation of a dark zone due to a distance difference between the light source 10 and different light emitting surface regions. However, since the protruding pattern 12 is formed using a mask and must have a predetermined area, the density of the protruding pattern 12 may only be adjusted using the size and interval of the pattern, thereby limiting an adjustment to the density of the protruding pattern 12. That is, it may be impossible to increase a density difference between the protruding pattern corresponding to a partial region close to the light source 10 and the protruding pattern 12 corresponding to another partial region distant from the light source 10. Accordingly, in the case of the conventional light guide plate 11 including the protruding pattern 12, as illustrated in FIG. 2, the right side of the light guide plate 11 distant from the light source 10 is remarkably darker than the left side of the light guide plate 11 close to the light source 10. The resulting dark zone may deteriorate the brightness of the backlight unit while also deteriorating the contrast radio of a display device.

For this reason, there is a need for a light guide plate having a pattern to minimize a dark zone due to a distance difference between a light source and different light emitting surface regions.

### SUMMARY OF THE INVENTION

Accordingly, the present invention is directed to a light guide plate and a backlight unit including the same that substantially obviate one or more problems due to limitations and disadvantages of the related art.

An object of the present invention is to provide a light guide plate capable of minimizing a dark zone, and a backlight unit including the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a light guide plate, having a light emitting surface to emit light supplied from a light source located at a side thereof, includes an intaglio pattern consisting of a plurality of recesses formed in a rear surface thereof opposite to the light emitting surface to have a cross section having a major axis diameter, a minor axis diameter and a depth, the recesses being spaced apart from one another in a first direction by a first distance and in a second direction by a second distance, wherein the density of the intaglio pattern is directly proportional to the major axis diameter, the minor axis diameter and the depth, and is inversely proportional to the first distance and the second distance, the intaglio pattern has the minimum density in a first region of the rear surface adjacent to the light source, and the maximum density in a second region of the rear surface that is the maximum distance from the light source, and a density ratio of the maximum density to the minimum density is 900.

In accordance with another aspect of the present invention, a light guide plate, having a light emitting surface to emit light supplied from a light source located at a side thereof, includes an intaglio pattern consisting of a plurality of recesses formed in a rear surface thereof opposite to the light emitting surface to have a cross section having a major axis diameter, a minor axis diameter and a depth, the recesses being spaced apart from one another in a first direction by a first distance and in a second direction by a second distance, wherein the density of the intaglio pattern is directly proportional to the major axis diameter, the minor axis diameter and the depth, and is inversely proportional to the first distance and the second distance, the intaglio pattern has the minimum density in a first region of the rear surface adjacent to the light source, and the maximum density in a second region of the rear surface that is the maximum distance from the light source, and a density difference between the maximum density and the minimum density is 107.88.

In accordance with a further aspect of the present invention, a backlight unit to irradiate light to a display panel includes a light source to supply light, a light guide plate having a light emitting surface to emit the light supplied from the light source located at a side thereof, and an optical sheet arranged on the light emitting surface of the light guide plate to perform diffusion or collection of light, wherein the light guide plate includes an intaglio pattern consisting of a plurality of recesses formed in a rear surface thereof opposite to the light emitting surface to have a cross section having a major axis diameter, a minor axis diameter and a depth, the recesses being spaced apart from one another in a first direction by a first distance and in a second direction by a second distance, the density of the intaglio pattern is directly proportional to the major axis diameter, the minor axis diameter and the depth, and is inversely proportional to the first distance and the second distance, and the intaglio pattern has the minimum density in a first region of the rear surface that is adjacent to the light source, and the minimum density is 0.12.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a light emission diagram of a conventional light guide plate having a protruding pattern.

FIG. 2 is an image of emission light of the light guide plate illustrated in FIG. 1.

FIG. 3 is a sectional view of a backlight unit according to an embodiment of the present invention.

FIG. 4 is a light emission diagram of the backlight unit illustrated in FIG. 3.

FIG. 5 is an image of emission light of a light guide plate of the backlight unit illustrated in FIG. 3.

FIG. 6 is a rear perspective view of the light guide plate according to one embodiment of the present invention.

FIG. 7 is a rear perspective view of the light guide plate according to another embodiment of the present invention.

FIG. 8 is a rear perspective view of the light guide plate according to a further embodiment of the present invention.

FIGS. 9A to 9E are images of emission light of the light guide plate depending on variation of the minimum/maximum density of an intaglio pattern.

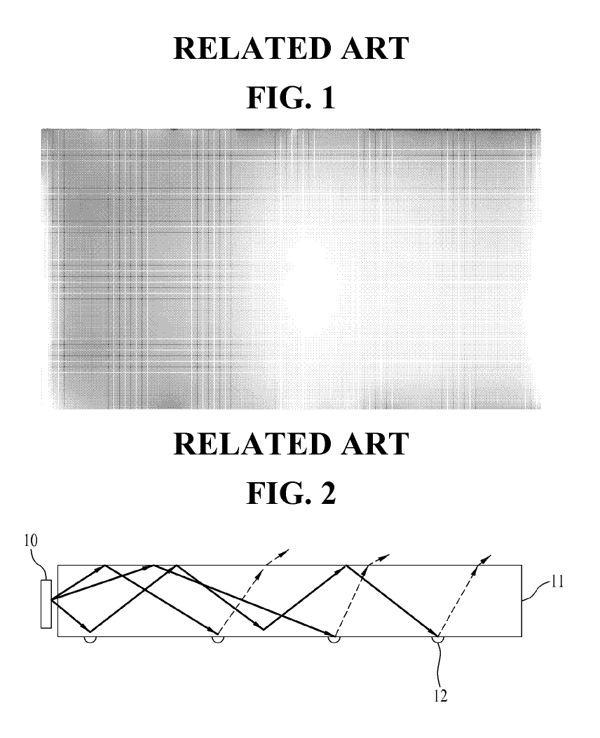

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, a light guide plate and a backlight unit including the same according to an embodiment of the present invention will be described in detail with reference to the accompanying drawings.

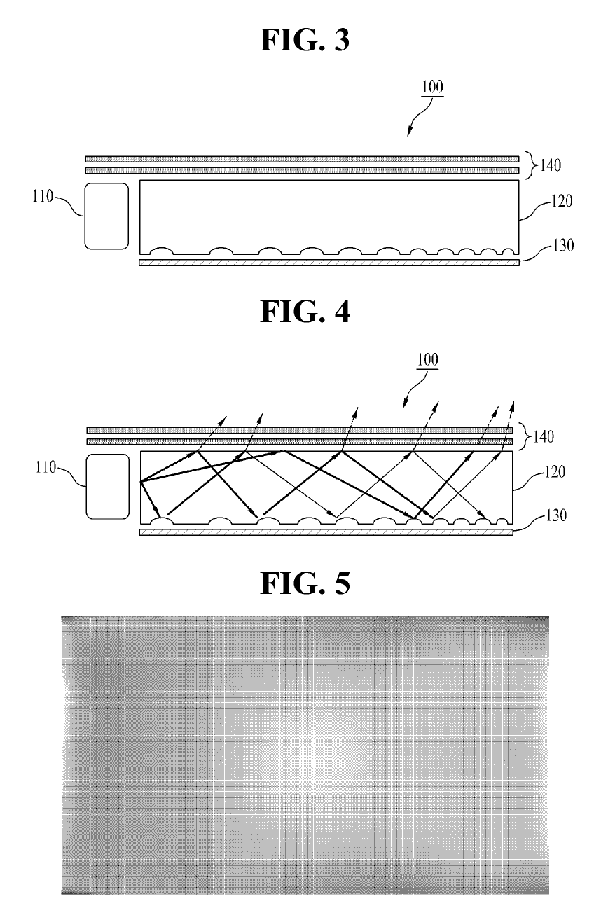

First, the backlight unit according to the embodiment of the present invention will be described with reference to FIGS. 3 to 5.

FIG. 3 is a sectional view of the backlight unit according to the embodiment of the present invention, FIG. 4 is a light emission diagram of the backlight unit illustrated in FIG. 3, and FIG. 5 is an image of emission light of a light guide plate of the backlight unit illustrated in FIG. 3.

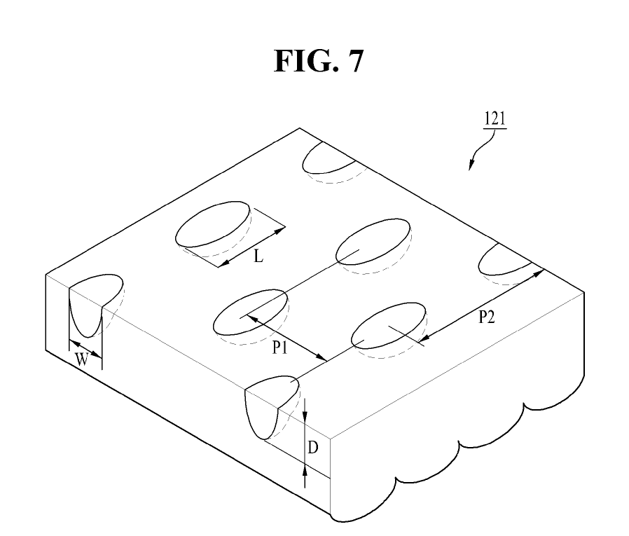

As illustrated in FIG. 3, the backlight unit 100 according to the embodiment of the present invention includes a light source 110, a light guide plate 120, a reflecting plate 130, and at least one optical sheet 140. The light source 110 is located in a non display region and supplies light. The light guide plate 120 serves to convert the light supplied from the light source 110 into planar light corresponding to a display region. The reflecting plate 130 is arranged on a rear surface of the light guide plate 120 and serves to reflect the light proceeding to the rear surface of the light guide plate 120. The optical sheet 140 is arranged on a front surface of the light guide plate 120 and performs diffusion and collection of the light emitted from the light guide plate 120. Here, the rear surface of the light guide plate 120, which is opposite to the front surface of the light guide plate 120 for emission of light (hereinafter, referred to as a “light emitting surface” and corresponding to an upper surface of the light guide plate 120 in FIG. 3), is provided with an intaglio pattern such that the density of the intaglio pattern increases in proportion to a distance from the light source 110. The intaglio pattern may consist of semispherical recesses having a semicircular or semi-oval cross section, or pyramidal recesses having a polygonal cross section. Also, the density of the intaglio pattern may gradually vary within an appropriate range. The intaglio pattern formed in the light guide plate 120 will be described hereinafter with reference to FIGS. 7, 8 and 9A to 9E.

The light source 110 may be selected from among a Hot Cathode Fluorescent Lamp (HCFL), Cold Cathode Fluorescent Lamp (CCFL), External Electrode Fluorescent Lamp (FEFL), Light Emitting Diode (LED), and so on. Although not shown, the backlight unit 100 further includes a power source to apply drive voltage to the light source 110.

The reflecting plate 130 is made of a thin reflective metal film.

As illustrated in FIG. 4, the backlight unit 100 is configured such that light emitted from the light source 110 is irradiated to a side surface of the light guide plate 120 to pass through the interior of the light guide plate 120 (in FIG. 4, the light is represented by solid arrows and hereinafter is referred to as “internal light”). A part of the internal light, an incidence angle of which is a specific critical angle or more, is restrained in the light guide plate 120, and the other part of the internal light is emitted to the outside from the light emitting surface of the light guide plate 120 (in FIG. 4, the light is represented by dotted arrows and hereinafter is referred to as “emission light”). That is, a part of the internal light (represented by the solid arrows), which has an incidence angle equal to or greater than a specific critical angle that causes total reflection is totally reflected in the light guide plate 120 and is restrained in the light guide plate 120, whereas the other part of the internal light (represented by the dotted arrows), which have an incidence angle smaller than the specific critical angle, is refracted at an interface between the light emitting surface of the light guide plate 120 and the atmosphere and is emitted to the outside.

In the meantime, the intaglio pattern formed in the rear surface of the light guide plate 120 acts to cause irregular reflection of the internal light. The intaglio pattern increases the possibility of providing the internal light with the incidence angle smaller than the specific critical angle, thereby increasing the quantity of emission light.

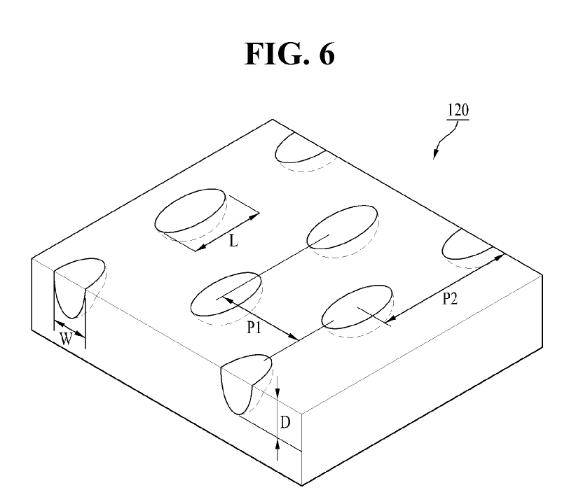

Hereinafter, the light guide plate according to the embodiment of the present invention will be described with reference to FIGS. 6 to 8.

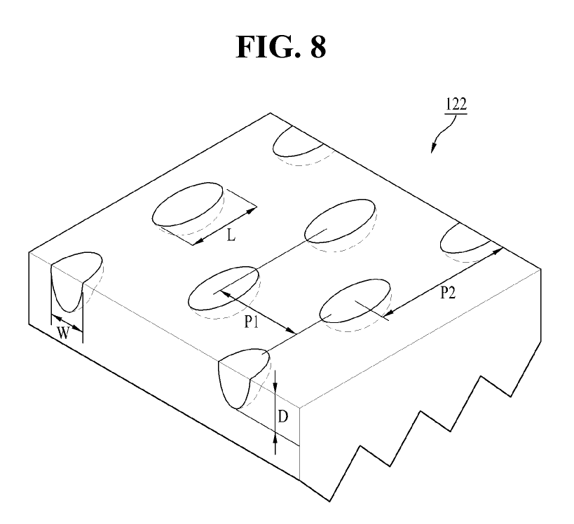

FIG. 6 is a rear perspective view of the light guide plate according to one embodiment of the present invention, FIG. 7 is a rear perspective view of the light guide plate according to another embodiment of the present invention, and FIG. 8 is a rear perspective view of the light guide plate according to a further embodiment of the present invention.

As illustrated in FIGS. 6 to 8, the intaglio pattern formed in the rear surface of the light guide plate 120, 121 or 122 may consist of semispherical recesses having an oval cross section. Although not illustrated, the intaglio pattern may consist of truncated conical or pyramidal recesses, or columnar recesses having a circular or polygonal cross section.

As illustrated in FIG. 6, the light emitting surface of the light guide plate 120 (corresponding to a lower surface of the light guide plate 120 in FIG. 6) according to the present embodiment may be a flat and smooth surface. Alternatively, to prevent light from being concentrated on any specific position of the light emitting surface, i.e. to cause dispersion or scattered reflection of light from the light emitting surface, the light emitting surface of the light guide plate may have a convex and concave pattern. Specifically, as illustrated in FIG. 7, the light emitting surface of the light guide plate 121 (corresponding to a lower surface of the light guide plate 121 in FIG. 7) according to another embodiment of the present invention may be patterned such that a plurality of columns having a semicircular or semi-oval cross section is arranged in parallel to each other. Alternatively, as illustrated in FIG. 8, the light emitting surface of the light guide plate 122 (corresponding to a lower surface of the light guide plate 122 in FIG. 8) may be patterned such that a plurality of triangular pyramids is arranged in parallel to each other.

As illustrated in FIGS. 6 to 8, on the basis of the rear surface of the light guide plate 120, 121 or 122, reference character “L” represents a major axis diameter of the cross section of the intaglio pattern, reference character “W” represents a minor axis diameter of the cross section of the intaglio pattern, reference character “D” represents the maximum depth of the intaglio pattern, reference character “P1” represents a distance between two adjacent recesses of the intaglio pattern in a minor axis direction (hereinafter, referred to as a distance on the basis of a minor axis), and reference character “P2” represents a distance between two adjacent recesses of the intaglio pattern in a major axis direction (hereinafter, referred to as a distance on the basis of a major axis). In this case, the density of the intaglio pattern may be defined by the following Equation 1.

$$ρ = \frac{LWD}{P 1 P 2} \qquad Equation 1$$

As illustrated in Equation 1, the density ρ of the intaglio pattern is directly proportional to the major axis diameter L, the minor axis diameter W and the maximum depth D of the cross section, and is inversely proportional to the distance on the basis of a minor axis P1 and the distance on the basis of a major axis P2.

As mentioned above, the internal light passing through the interior of the light guide plate 120 may be reflected at an angle smaller than a specific critical angle by the intaglio pattern of the light guide plate 120, thereby being emitted from the light guide plate 120. It can be appreciated that the emission of light is caused by the intaglio pattern and thus, the quantity of emission light is proportional to the density of the intaglio pattern. Accordingly, if the density of the intaglio pattern is adjusted to assure uniform emission of light from the entire light emitting surface, it may be possible to prevent generation of a dark zone in which a specific region of the light emitting surface is darker than other regions, or to prevent concentration of light in which a specific region of the light emitting surface is brighter than other regions.

In particular, the concentration of light mainly occurs in a region adjacent to the light source 110 (hereinafter, referred to as “a proximal region”), and a dark zone mainly occurs in a region distant from the light source 110 to the maximum extent (hereinafter, referred to as “the maximum distal region”). To prevent the concentration of light or the generation of a dark zone, the intaglio pattern has the minimum density in the proximal region of the rear surface of the light guide plate 120, 121 or 122, and has the maximum density in the maximum distal region of the rear surface of the light guide plate 120, 121 or 122. The density of the intaglio pattern formed throughout different regions of the rear surface of the light guide plate 120, 121 or 122 gradually varies between the minimum density of the proximal region and the maximum density of the maximum distal region according to a distance between different regions and the light source.

Hereinafter, the minimum density and the maximum density of the intaglio pattern corresponding respectively to the proximal region and the maximum distal region to minimize the concentration of light and the generation of a dark zone will be described on the basis of a 42″ display region.

Considering the light guide plate having the intaglio pattern, the density of which gradually varies from the minimum density to the maximum density, on the basis of the 42″ display region, the minimum density ρ_{MIN} of the intaglio pattern corresponding to the proximal region is 0.12 as calculated by the following Equation 2, and the maximum density ρ_{MAX} of the intaglio pattern corresponding to the maximum distal region is 108 as calculated by the following Equation 3.

$$\begin{matrix}{ρ}_{MIN} = \frac{LWD}{P 1 P 2} = \frac{100 \times 160 \times 30}{2000 \times 2000} = 0.12 & Equation 2 \\ {ρ}_{MAX} = \frac{LWD}{P 1 P 2} = \frac{4500 \times 180 \times 100}{500 \times 1500} = 108 & Equation 3\end{matrix}$$

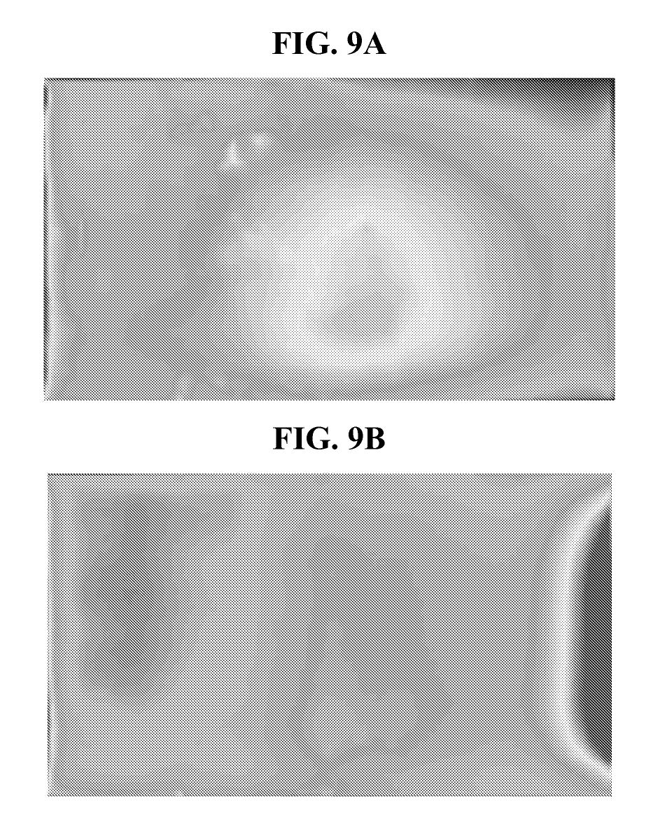

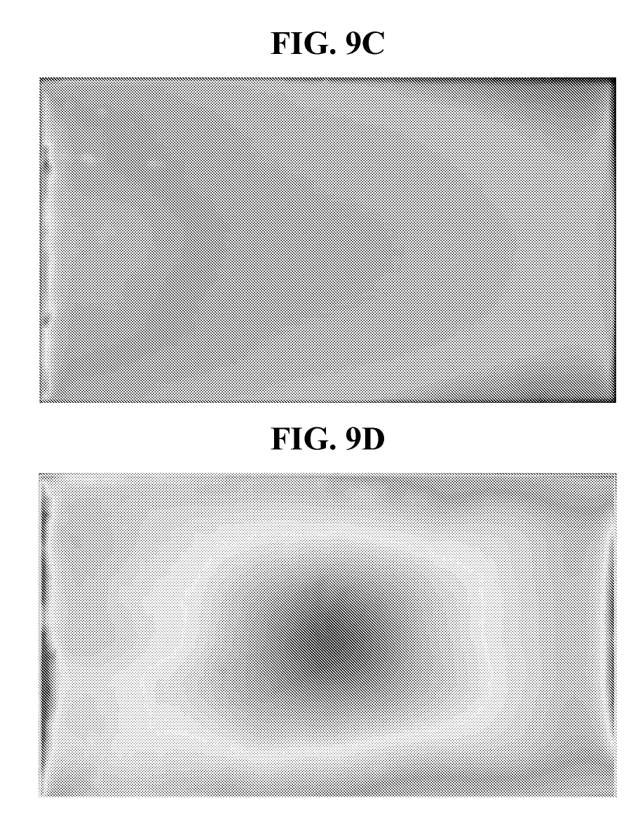

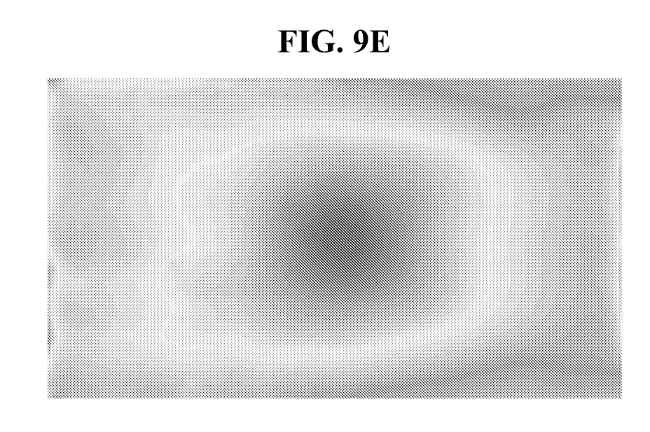

For example, on the basis of the 42″ display region, assuming that the ratio of the maximum density ρ_{MAX} to the minimum density ρ_{MIN} (hereinafter, referred to as “a density ratio”) is 900, and a difference between the maximum density ρ_{MAX} and the minimum density ρ_{MIN} (hereinafter, referred to as “a density difference”) is 107.88, the concentration of light and the generation of a dark zone may be minimized. This can be appreciated from FIGS. 9A to 9E.

FIGS. 9A to 9E are images of emission light of the light guide plate depending on variation of the minimum/maximum density of the intaglio pattern.

Specifically, FIG. 9A illustrates an image of the emission light of the light guide plate in the case where the minimum density and the maximum density of the intaglio pattern calculated by Equation 2 and Equation 3 are applied, i.e. the minimum density of the proximal region is 0.12 and the maximum density of the maximum distal region is 108. FIGS. 9B and 9C illustrate images of the emission light of the light guide plate in the case where the minimum densities of the proximal region are 0.11 and 0.13 respectively and the maximum density of the maximum distal region is 108. Also, FIGS. 9D and 9E illustrate images of the emission light of the light guide plate in the case where the minimum density of the proximal region is 0.12 and the maximum densities of the maximum distal region are 105 and 107 respectively.

Comparative results of FIGS. 9A to 9E are summarized in the following Table 1.

TABLE 1

| | | FIG. 9A | FIG. 9B | FIG. 9C | FIG. 9D | FIG. 9E |
|---|---|---|---|---|---|---|
| Density | Proximal | 0.12 | 0.11 | 0.13 | 0.12 | 0.12 |
| of | Region | | | | | |
| Intaglio | Maximum | 108 | 108 | 108 | 105 | 107 |
| Pattern | Distal | | | | | |
| | Region | | | | | |
| Density | | 107.88 | 107.89 | 107.87 | 104.88 | 106.88 |
| Difference | | | | | | |
| Density Ratio | | 900 | 981.82 | 830.77 | 875 | 891.667 |
| Comparative note | | — | Dark zone | Dark zone | concentration | concentration |
| with FIG. 9A | | | occurs in the | occurs at the | of light occurs | of light occurs |
| | | | proximal | edge of the | in the maximum | in the central |
| | | | region | maximum | distal region | region |
| | | | | distal region | and the central | |
| | | | | | region | |

As illustrated in Table 1, comparing the images of the emission light of FIGS. 9A and 9B in which the minimum densities of the intaglio pattern formed in the proximal region are 0.12 and 0.11 respectively, the proximal region in which the minimum density of the intaglio pattern is 0.11 may not emit a required quantity of light, thereby generating a dark zone (see the left side of FIGS. 9A and 9B). Accordingly, the minimum density of the intaglio pattern must be greater than a predetermined value of 0.12.

On the other hand, comparing the images of the emission light of FIGS. 9A and 9C in which the minimum densities of the intaglio pattern formed in the proximal region are 0.12 and 0.13 respectively, the proximal region in which the minimum density of the intaglio pattern is 0.13 may emit a greater quantity of light than the maximum distal region. In this case, a dark zone may occur in the maximum distal region.

As represented in Table 1, comparing the images of the emission light of FIGS. 9A, 9D and 9E in which the maximum densities of the intaglio pattern formed in the maximum distal region are 108, 105 and 107 respectively, the maximum distal region in which the maximum density of the intaglio pattern is 105 or 107 may cause concentration of light on the central region because the intaglio pattern formed in the maximum distal region reflects light to the central region.

Accordingly, the minimum density of the intaglio pattern must be determined to assure the emission of light from the proximal region. Also, to increase the density ratio or density difference between the minimum density and the maximum density, the maximum density of the intaglio pattern must be determined to have the greatest value in consideration of the size of the display region. In particular, the minimum density is preferably 0.12, and the density ratio and the density difference between the minimum density and the maximum density are preferably 900 and 107.88, respectively, on the basis of the 42″ display region.

As described above, the light guide plate according to the present invention is provided at the rear surface thereof with the intaglio pattern such that the density of the intaglio pattern is changed from the minimum density of 0.12 corresponding to the proximal region to the maximum density of 108 corresponding to the maximum distal region in consideration of a distance between different regions and the light source, thereby minimizing the generation of a dark zone or the concentration of light. This may result in enhancement in the brightness of the light emitting surface of the light guide plate and consequently, enhancement in the contrast ratio of a display device that displays an image using light emitted from the backlight unit including the light guide plate.

Although the light guide plate 120 according to the embodiment of the present invention is described and illustrated as receiving light from the light source 110 provided at one corner of the light guide plate 120, it will be appreciated that a plurality of light sources may be arranged at a pair of opposite corners or four corners of the light guide plate. In this case, similarly, the minimum density of the intaglio pattern corresponding to the proximal region that is adjacent to the light source 110 is preferably 0.12, and the maximum density of the intaglio pattern corresponding to the maximum distal region that is the maximum distance from the light source 110 is preferably determined such that the density ratio and the density difference between the minimum density and the maximum density of the intaglio pattern are 900 and 107.88, respectively. In addition, although the embodiment of the present invention assumes a 42″ display region by way of example, the above described ratio value of the 42″ display region may be applied even to different sizes of display regions in consideration of the area of the display region and the distance from the light source.

As is apparent from the above description, a light guide plate according to the present invention is provided, at a rear surface thereof opposite to a light emitting surface thereof, with an intaglio pattern consisting of a plurality of recesses. Each of the recesses of the intaglio pattern has a cross section having a predetermined major axis diameter, a predetermined minor axis diameter and a predetermined depth. The recesses are spaced apart from one another in a first direction by a first distance and in a second direction by a second distance. Here, the intaglio pattern has the minimum density in a first region of the rear surface adjacent to a light source and the maximum density in a second region of the rear surface that is the maximum distance from the light source, to prevent the generation of a dark zone. The density difference between the minimum density and the maximum density is 107.88, and the density ratio of the maximum density to the minimum density is 900. That is, the light guide plate according to the present invention includes the intaglio pattern having the minimum density and the maximum density determined in consideration of a distance between the first or second region and the light source, thereby minimizing the generation of a dark zone or concentration of light. This may enhance the contrast ratio of a display device that displays an image using light emitted from a backlight unit including the light guide plate.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A light guide plate having a light emitting surface to emit light supplied from a light source located at a side thereof, the light guide plate comprising:
an intaglio pattern consisting of a plurality of recesses formed in a rear surface thereof opposite to the light emitting surface to have a cross section having a major axis diameter, a minor axis diameter and a depth, the recesses being spaced apart from one another in a first direction by a first distance and in a second direction by a second distance,
wherein the density of the intaglio pattern is directly proportional to the major axis diameter, the minor axis diameter and the depth, and is inversely proportional to the first distance and the second distance,
wherein the intaglio pattern has the minimum density in a first region of the rear surface adjacent to the light source, and the maximum density in a second region of the rear surface that is the maximum distance from the light source, and
wherein a density ratio of the maximum density to the minimum density is 900.

2. The light guide plate according to claim 1, wherein the minimum density is 0.12.

3. The light guide plate according to claim 1, wherein the maximum density is 108.

4. The light guide plate according to claim 1, further comprising: a pattern consisting of a plurality of columns formed on the light emitting surface so as to be arranged in parallel to each other and having a polygonal, semicircular, or semi-oval cross section.

5. The light guide plate according to claim 1, wherein the density of the intaglio pattern formed in the rear surface gradually varies between the minimum density and the maximum density.

6. A light guide plate having a light emitting surface to emit light supplied from a light source located at a side thereof, the light guide plate comprising:
an intaglio pattern consisting of a plurality of recesses formed in a rear surface thereof opposite to the light emitting surface to have a cross section having a major axis diameter, a minor axis diameter and a depth, the recesses being spaced apart from one another in a first direction by a first distance and in a second direction by a second distance,
wherein the density of the intaglio pattern is directly proportional to the major axis diameter, the minor axis diameter and the depth, and is inversely proportional to the first distance and the second distance,
wherein the intaglio pattern has the minimum density in a first region of the rear surface adjacent to the light source, and the maximum density in a second region of the rear surface that is the maximum distance from the light source, and
wherein a density difference between the maximum density and the minimum density is 107.88.

7. The light guide plate according to claim 6, wherein the minimum density is 0.12.

8. The light guide plate according to claim 6, wherein the maximum density is 108.

9. The light guide plate according to claim 6, further comprising: a pattern consisting of a plurality of columns formed on the light emitting surface so as to be arranged in parallel to each other and having a polygonal, semicircular, or semi-oval cross section.

10. The light guide plate according to claim 6, wherein the density of the intaglio pattern formed in the rear surface gradually varies between the minimum density and the maximum density.

11. A backlight unit to irradiate light to a display panel, comprising:
a light source to supply light;
a light guide plate having a light emitting surface to emit the light supplied from the light source located at a side thereof; and
an optical sheet arranged on the light emitting surface of the light guide plate to perform diffusion or collection of light,
wherein the light guide plate includes an intaglio pattern consisting of a plurality of recesses formed in a rear surface thereof opposite to the light emitting surface to have a cross section having a major axis diameter, a minor axis diameter and a depth, the recesses being spaced apart from one another in a first direction by a first distance and in a second direction by a second distance,
wherein the density of the intaglio pattern is directly proportional to the major axis diameter, the minor axis diameter and the depth, and is inversely proportional to the first distance and the second distance, and
wherein the intaglio pattern has the minimum density in a first region of the rear surface that is adjacent to the light source, and the minimum density is 0.12.

12. The backlight unit according to claim 11, wherein the intaglio pattern has the maximum density in a second region of the rear surface that is the maximum distance from the light source, and the maximum density is 108.

13. The backlight unit according to claim 11, wherein the density of the intaglio pattern formed in the rear surface gradually varies between the minimum density and the maximum density.

14. The backlight unit according to claim 11, wherein the light guide plate further includes a pattern consisting of a plurality of columns formed on the light emitting surface so as to be arranged in parallel to each other and having a polygonal, semicircular, or semi-oval cross section.
